(19) United States
(12) Patent Application Publication
(10) Pub. No.: US 2009/0041544 A1
(43) Pub. Date: Feb. 12, 2009

(54) Geonet for a geocomposite

(76) Inventor: Boyd J. Ramsey, The Woodlands, TX (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/891,168

(22) Filed: Aug. 9, 2007

(51) Int. Cl. B29C 47/06; B09B 1/00; B32B 3/10

(52) U.S. Cl. 405/129.95; 264/151; 428/131

(57) ABSTRACT

A geonet having a length substantially greater than its width and including no more than first and second layers of strands. A first plurality of substantially parallel strands extends in the lengthwise direction and defines the first layer of strands, and a second plurality of substantially parallel strands is disposed on top of, and at an angle relative to, the first plurality of strands and defines the second layer of strands. The first and second plurality of strands are substantially incompressible and secured to one another at crossover locations. Geocomposites include geotextile bonded to at least one side of the geonet. The geonets/geocomposites are laid in geotechnical construction sites in the direction of expected drainage flow.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention is directed toward geocomposites for use in geotechnical construction sites, and particularly toward geonets usable with geotextiles in forming such geocomposites.

### BACKGROUND OF THE INVENTION AND TECHNICAL PROBLEMS POSED BY THE PRIOR ART

Geotechnical engineering and the usage of geosynthetic materials are very common in today's civil engineering marketplace. One of the most common geosynthetic material available today are drainage products. Drainage products are generally comprised of a geonet or material or a geonet combined with a filtration fabric which may be one of many varieties. These products are used for a broad variety of applications. Common applications include drainage/leachate collection layers in waste storage facilities, leak detection layers in waste storage facilities, the use of a geosynthetic drainage material for gas venting in water and wastewater storage and treatment facilities, the use of geosynthetic drainage layers in roadway, rail and transportation applications and many others. In all of these applications, there are generally two performance factors which determine the suitability of the drainage media. These performance factors are the transmissivity (flow capacity) of the drainage media and the maximum allowable overburden pressure which the drainage media can support and still perform the functions required of it.

Waste collection sites are, of course, one well known type of geotechnical construction site, and are unavoidably required in today's societal structures. Such sites can require large amounts of valuable land, particularly in urban areas where large amounts of waste are generated and, at the same time, land is most in demand. Also, while desirable uses can be made of such lands (for example, golf courses have been built on such sites), such desirable uses typically have to wait until the land is no longer being used for collect further waste and the often high pile of waste has stabilized. While use and stabilization of such sites can take many years, there is nevertheless a desire to have that accomplished as quickly as possible, not only to increase the safety of those who might have to be at the site but also to allow for the desired use of others (for example, golfers) and to enhance the environment of those who live in the area as soon as is reasonably possible.

Toward that end, bioreactor landfills have been used to modify solid waste landfills by re-circulating and injecting leachate/liquid and air to enhance the consolidation of waste and reduce the time required for landfill stabilization. To accomplish this, generally horizontal flow of the leachate/liquid beneath the surface of the landfill is required. In some instances, vertical injection pipes and horizontal pipe fields have often been used to facilitate this leachate/liquid flow. With these structures, geocomposites are commonly provided in spaced layers of the built up land masses. Other masses may use such geocomposites where drainage (e.g., along a highway edge), leachate collection (e.g., at the bottom of a landfill), or gas removal (e.g., under a building slab) are required. Such geocomposites facilitate desired lateral drainage, collection and/or circulation of fluids (including liquids and/or gases) in the land mass. U.S. Pat. No. 6,802,672 discloses one advantageous system directed toward such problems.

It is desirable to provide geotextiles which will allow for large fluid flow rates along the geotextile. However, given the large loads which such geotextiles are subjected to as more and more layers of land mass are piled on top of the layers, compression and/or collapse of the geotextile and result, thereby reducing the flow rate through the geotextile. Further, while additional components, etc. may be added to strengthen the geotextile against collapse, those additional components may themselves block and thereby reduce the flow rate as well.

The present invention is directed toward overcoming one or more of the problems set forth above.

### SUMMARY OF THE INVENTION

In one aspect of the present invention, a geonet for use in a geotechnical construction site is provided with a length substantially greater than its width. The geonet includes no more than first and second layers of strands, where a first plurality of substantially parallel strands extends in the lengthwise direction and defines the first layer of strands, and a second plurality of substantially parallel strands is disposed on top of the first plurality of strands and defines the second layer of strands, the second plurality of strands being at an angle relative to the first plurality of strands. The first and second plurality of strands are substantially incompressible and secured to one another at crossover locations.

In one form of this aspect of the present invention, at least one of the first and second plurality of strands is substantially round in cross-section.

In another form of this aspect of the present invention, the geonet is stored in a roll having X number of layers with each strand of the first layer of strands being rolled X times.

In still another form of this aspect of the present invention, the first layer of strands is the bottom layer of strands when installed, and strands of the first plurality of strands are substantially round in cross-section.

In yet another form of this aspect of the present invention, the strands of the second plurality of substantially parallel strands are at an angle of 45° to 70° relative to the first plurality of strands.

According to another form of this aspect of the present invention, the strands are polyethylene (PE).

In another aspect of the present invention, a geocomposite for use in a geotechnical construction site is provided, including a geonet having a length substantially greater than its width, and with no more than first and second layers of strands. A first plurality of substantially parallel strands extends in the lengthwise direction and defines the first layer of strands, and a second plurality of substantially parallel strands disposed on top of the first plurality of strands defines the second layer of strands. The second plurality of strands is at an angle relative to the first plurality of strands, and the first and second plurality of strands are substantially incompressible and secured to one another at crossover locations. A geotextile is bonded to at least one side of the geonet.

In one form of this aspect of the present invention, at least one of the first and second plurality of strands is substantially round in cross-section.

In another form of this aspect of the present invention, both of the first and second plurality of strands are substantially round in cross-section.

In yet another form of this aspect of the present invention, the geotextile is non-woven textile laminated to the outer faces of the layers of strands. In a further form, the strands are polyethylene (PE) and, in another form, the geotextile is non-woven needlepunched textile laminated to strands on both sides of the geonet.

In still another form of this aspect of the present invention, the geocomposite is stored in a roll having X number of layers with each strand of the first layer of strands being rolled X times.

In another form of this aspect of the present invention, the geotextile is spun-bonded or needlepunched non-woven textile laminated to strands on both sides of the geonet.

In still another aspect of the present invention, a landfill includes alternating layers of fill and geocomposites, with the geocomposites each disposed beneath a layer of fill to facilitate draining of liquid from the landfill. The geonet has a length substantially greater than its width with a geotextile bonded to at least one side. The geonet has no more than first and second layers of strands, where a first plurality of substantially parallel strands extends in the lengthwise direction and defines the first layer of strands, and a second plurality of substantially parallel strands is disposed on top of the first plurality of strands and defines the second layer of strands. The second plurality of strands are at an angle relative to the first plurality of strands, and the first and second plurality of strands are substantially incompressible and secured to one another at crossover locations.

In one form of this aspect of the present invention, at least one of the first and second plurality of strands is substantially round in cross-section.

In another form of this aspect of the present invention, the strands are polyethylene (PE).

In yet another aspect of the present invention, a method of making a geonet for use in a geotechnical construction site includes first providing a mold for extruded material. The mold includes a first mold member having an outer boundary cylindrical about an axis and defining a first plurality of strand defining openings open at the outer boundary and spaced around the outer boundary, and a second mold member concentric with the first mold member and having a cylindrical inner boundary defining a second plurality of strand defining openings open at the inner boundary and spaced around the inner boundary. Further to the method, extruded material is forced through the first and second plurality of strand defining openings while one of the first and second mold members is stationary and the other of the first and second mold members rotates to define a cylindrical net with the strands defined by the openings of the one of the first and second mold members each extending substantially parallel to the axis and the strands defined by the openings of the other of the first and second mold members spiraling around the cylindrical net. According to the method, the strands defined by the other of the first and second mold members are then cut along a line substantially parallel to the axis, the cut cylindrical net is flattened to generally orient the strands in a plane, and the flattened net is rolled whereby the strands defined by the one of the first and second mold members are coiled.

In one form of this aspect of the present invention, the openings of the first plurality of openings are open to openings of the second plurality of openings when the openings of the first and second plurality of openings are aligned along a radius of the axis during relative rotation of the first and second mold members.

In another form of this aspect of the present invention, one of the first and second plurality of openings is substantially rectangular in cross-section.

In still another form of this aspect of the present invention, the other of the first and second mold members rotates at a rate whereby the strands molded thereby are at an angle of 45° to 70° relative to the strands molded by the one of the first and second mold members.

In yet another aspect of the present invention, a method of making a landfill includes alternating layers of fill and geonets so that the geonets are each disposed beneath a layer of fill to facilitate draining of liquid from the landfill. The method includes rolling a geonet made according to the previously described aspect of the invention beneath each layer of landfill in the direction of expected drainage flow.

### BRIEF DESCRIPTION OF THE DRAWINGS

FIG. 1 is a perspective view of one embodiment of a geonet according to the present invention;

FIG. 2 is a cross-sectional view of the one embodiment of a geonet according to the present invention, taken along line 2-2 of FIG. 1;

FIG. 3 is an enlarged cross-section view of a geocomposite according to the present invention including a geotextile on both the top and bottom of the geonet of FIGS. 1-2, oriented according to line 3-3 of FIG. 1;

FIG. 4 is a perspective view of another embodiment of a geonet according to the present invention;

FIG. 5 is a cross-sectional view of the geonet of the second embodiment, taken along line 5-5 of FIG. 4;

FIG. 6 is an enlarged side view of a geocomposite according to the present invention including a geotextile on both the top and bottom of the geonet of FIGS. 5-6, oriented according to line 6-6 of FIG. 4;

FIG. 7 is an end view of a mold structure which may be used to make the geonets of FIGS. 4-5;

FIG. 8 is a perspective view illustrating the unwrapping of the molded cylindrical geonet to a flat longitudinal layer;

FIG. 9 is a partial view of another mold structure which may be used to make other geonet configurations embodying some aspects of the present invention; and

FIG. 10 is a cross-section of a landfill in which the geocomposite of the present invention is used.

### DETAILED DESCRIPTION OF THE INVENTION

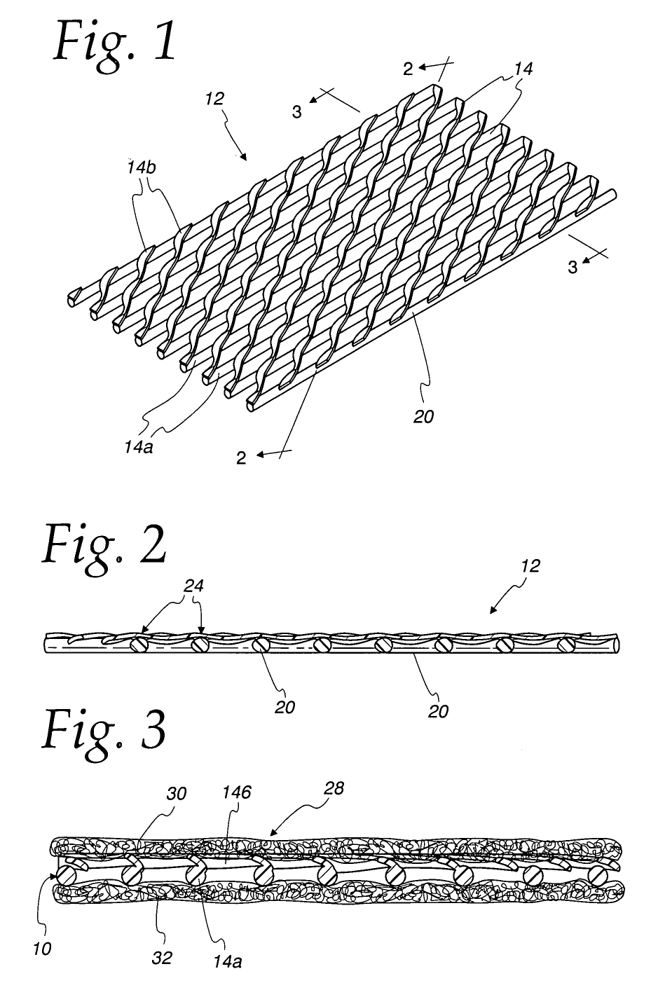

One embodiment of a geonet 12 according to the present invention is shown in FIGS. 1-2. The geonet 12 consists of substantially incompressible longitudinal strands 14 (e.g., formed of polyethylene [PE], including but not limited to high density polyethylene [HDPE]), including a lower set of a plurality of substantially parallel strands 14a and an upper set of a plurality of substantially parallel strands 14b. Advantageously, one set of strands 14a extends parallel to the longitudinal direction of the geonet 12, and the other set of strands 14b is at an angle of 45° to 70° relative to the longitudinal strands 14a so that a crisscrossed grid 20 is formed (see FIG. 1).

It should be understood that as used herein, “substantially incompressible” is meant to refer to materials such as HDPE which, though susceptible to bending, breaking, fracture and/or creep, does not appreciably compress in the vertical direction when vertical forces are applied.

At their overlapping intersection, the strands 14a, 14b are suitably secured together whereby a relatively rigid geonet 12 is provided in the plane of the geonet 12 (i.e., the geonet 12 is substantially rigid against compressive forces directed along the plane of the geonet 12, while still providing some flexibility for bending when laid on uneven ground).

In accordance with this embodiment, the lower set of strands 14a of the geonet 12 are substantially round in cross-section with connected areas 24 at the overlapping intersections. Such a cross-section provides a reduced risk of failure due to the strands 14a laying or folding over due to the pressures encountered in use. Advantageously, the diameter of the strands 14a, 14b may, for a given design use, be substantially the same as the longer dimension of the prior art flat strands.

A geocomposite 28 incorporating the geonet 12 of FIGS. 1-2 is shown in FIG. 3. In the illustrated geocomposite 28, geotextiles 30, 32 (such as, e.g., non-woven needlepunched geotextiles, spun-bonded or laminated textiles, as are known in the art) are suitably secured to both sides of the geonet 12, such as by heat laminating.

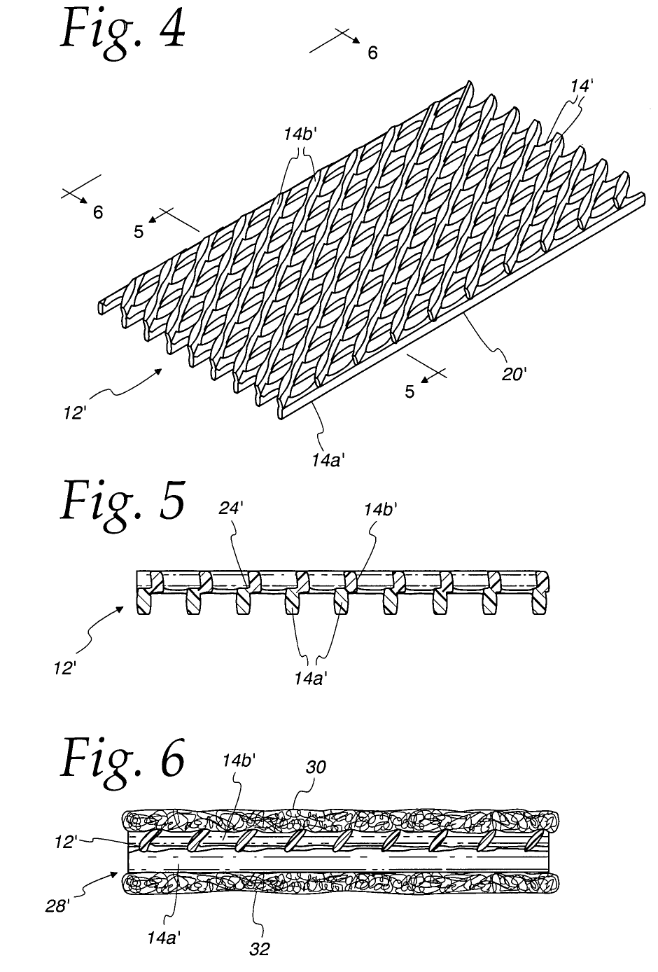

A second embodiment of a geonet 12 according to the present invention is shown in FIGS. 4-5. (Comparable reference numerals to those used in describing the FIGS. 1-2 embodiment are used herein, with similar but modified components having the same reference numeral with prime [′] added [e.g., 12 in FIGS. 1-2 is 12′ in FIGS. 4-5]).

The geonet 12′ consists of substantially incompressible longitudinal strands 14′ (e.g., formed of polyethylene [PE], including but not limited to high density polyethylene [HDPE]), including a lower set of a plurality of substantially parallel strands 14a′ and an upper set of a plurality of substantially parallel strands 14b′. Advantageously, one set of strands 14a′ extends parallel to the longitudinal direction of the geonet 12′, and the other set of strands 14b′ is at an angle of 45° to 70° (advantageously 60°) relative to the longitudinal strands 14a′ so that a crisscrossed grid 20′ is formed (see FIG. 4).

At their overlapping intersection, the strands 14a′, 14b′ are suitably secured together whereby a relatively rigid geonet 12′ is provided in the plane of the geonet 12′ (i.e., the geonet 12′ is substantially rigid against compressive forces directed along the plane of the geonet 12′, while still providing some flexibility for bending when laid on uneven ground).

In accordance with this embodiment, both the lower and upper sets of strands 14a′, 14b′ are substantially rectangular in cross-section with connected areas 24′ at the overlapping intersections. Advantageously, the height of the strands 14a′, 14b′ may, for a given design use, be substantially the same as the longer dimension of the prior art flat strands.

A geocomposite 28′ incorporating the geonet 12′ of the FIGS. 4-5 is shown in FIG. 6. In the illustrated geocomposite 28′, geotextiles 30, 32 are suitably secured to both sides of the geonet 12′, such as by heat laminating.

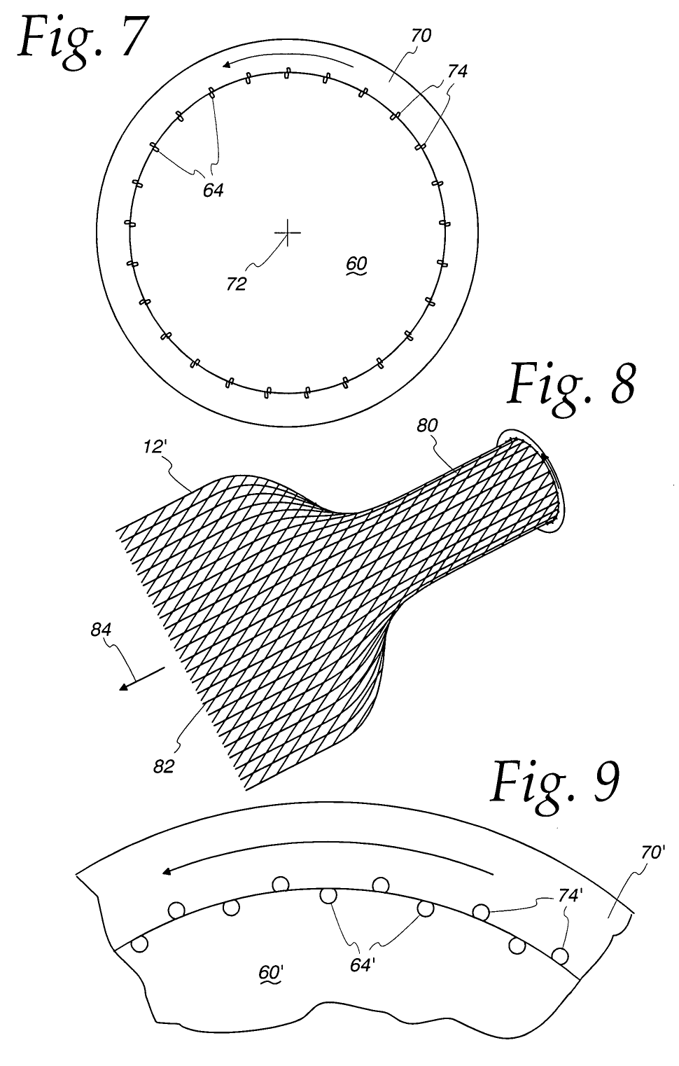

FIG. 7 illustrates an exemplary mold structure through which extruded material may be forced (pulled) to advantageously form the geonet 12′ of FIGS. 4-5. Specifically, the geonet 12′ may first be formed in a tubular shape with a cylindrical inner mold 60 having rectangular strand defining openings 64 spaced around the exterior boundary of the mold 60. An outer mold 70 is supported for rotation around the central axis 72 and includes strand defining openings 74 spaced around its inner cylindrical surface.

As generally illustrated in FIG. 8, the formed cylindrical geonet 80 may be longitudinally cut as it is molded with the geonet 80 then spread out to a suitable flat configuration (82) having a width substantially equal to the diameter of mold 60 times π (pi) and virtually any selected length in the direction of arrow 84. It should be appreciated that maintaining mold 60 stationary while rotating mold 70 during molding will result in the desired longitudinal orientation of strands 14a′ in the direction of arrow 84 and the angled orientation of strands 14b′. Desired significant lengths of the geonet 80 may be cut, geotextiles 30′, 32′ added as desired, and then rolled into a coil for convenient transport and handling. When rolled, the geonet 80 is in a coil having X number of layers (as measured outwardly from the coil center) with each of the longitudinal strands 14a′ being rolled X times (meaning that each longitudinal strand 14a′ is coiled from the center of the roll to the outer layer of the roll).

FIG. 9 shows an alternate mold configuration, in which the inner mold 60′ includes round openings 64′ and the outer mold 70′ also includes round openings 74′, such as may be used to provide round strands in both sets of strands. Round strands have been found to be particularly advantageous in some applications as disclosed in U.S. patent application Ser. No. 11/271,396, filed Nov. 10, 2005, the disclosure of which is hereby incorporated by reference. It should, however, be understood that various advantages of the present invention could be obtained with a wide variety of strand shapes. For example, round openings in the inner mold and rectangular openings in the outer mold would be used to produce the geonet 12 illustrated in FIGS. 1-2.

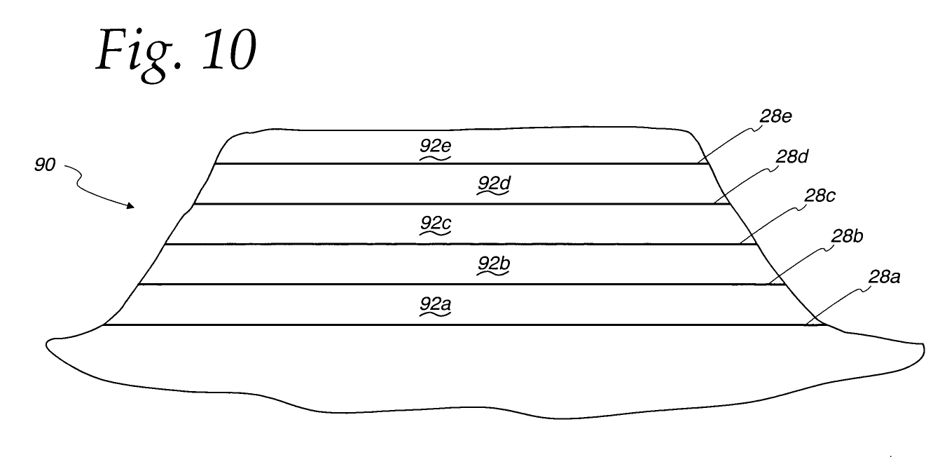

FIG. 10 illustrates, in cross-section, a landfill 90 in which geocomposites 28 according to the present invention may be advantageously used. As the landfill is made, a first layer of geocomposites 28a is laid down on the surface of the area on which the landfill 90 is being formed. Of course, the area being covered may be extremely large, and therefore more than one section or roll of geocomposite 28a will typically be required to cover the entire area at each layer. In accordance with this aspect of the invention, the geocomposite 28a is rolled in the direction of expected fluid flow so that the longitudinal strands 14a are oriented in the direction of expected fluid flow.

Fill 92a will then be placed on top of the geocomposite 28a to a desired depth such as is known in the art, and then a second layer of geocomposites 28b is then laid down on that area in the orientation of expected fluid flow for that layer. Further layers of fill 92b-92e and geocomposites 28c-28e are similarly added according to the design of the landfill 90. As is known to those skilled in the art, geocomposites 28a-28e such as illustrated may be used to facilitate fluid flow through the landfill 90. Moreover, other structures, such as pumps and vertical and horizontal pipes, may also be used in conjunction with such geocomposites 28a-28e if desired to intentionally circulate leachate through the landfill and thereby facilitate stabilization of the landfill 90 so that it may thereafter be returned to other productive uses more quickly. Further, geocomposites 28 only about 0.200 inch thick may be used, for example, in place of twelve inch layers of sand and aggregate, thereby requiring much less height and concomitantly having less environmental impact and/or allowing for more fill (e.g., waste in a landfill).

It has been found that desired high transmissivities may be provided by geonets having the strands configured according to the present invention, with transmissivities maintained in the direction of the bottom strands 14a, 14a′ under the wide range of conditions which may be encountered (including interface, gradient, seat time and pressure). Moreover, this configuration allows for extremely high flow rates while at the same time using a very low weight per unit are of the material for such geonets 12, 12′. For example, at higher pressures such as 10,000 pounds per square foot, such as may be encountered in site designs involving several hundred thousand to over a million square feet and projected overburden heights of zero to over two hundred feet, significantly greater fluid flow along the generally horizontal geonet 12 may be provided, and/or significantly less geonet materials may be used, than with geonets not embodying the present invention. Thus, geocomposites 28 such as described herein may be advantageously used particularly in large landfills where they are subjected to high pressures over long periods of time. However, it should further be understood that geonets 12 and geocomposites 28 according to the present invention, though advantageously usable in geotechnical construction sites such as landfills 90 as described above, may also be advantageously usable in a wide variety of geotechnical construction sites, including not only common horizontal orientations facilitating drainage over a site but also vertical orientations such as in mechanically stabilized earth walls.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A geonet for use in a geotechnical construction site, said geonet having a length substantially greater than its width, comprising no more than first and second layers of strands, where
a first plurality of substantially parallel strands extends in the lengthwise direction and defines the first layer of strands;
a second plurality of substantially parallel strands is disposed on top of said first plurality of strands and defines the second layer of strands, said second plurality of strands being at an angle relative to said first plurality of strands; and
said first and second plurality of strands are substantially incompressible and secured to one another at crossover locations.

2. The geonet of claim 1, wherein at least one of said first and second plurality of strands is substantially round in cross-section.

3. The geonet of claim 1, wherein said geonet is stored in a roll having X number of layers with each strand of said first layer of strands being rolled X times.

4. The geonet of claim 1, wherein said first layer of strands is the bottom layer of strands when installed, and strands of said first plurality of strands are substantially round in cross-section.

5. The geonet of claim 1, wherein said strands of said second plurality of substantially parallel strands are at an angle of 45° to 70° relative to said first plurality of strands.

6. The geonet of claim 1, wherein said strands are polyethylene (PE).

7. A geocomposite for use in a geotechnical construction site, comprising:
a geonet having a length substantially greater than its width, comprising
no more than first and second layers of strands, where
a first plurality of substantially parallel strands extends in the lengthwise direction and defines the first layer of strands,
a second plurality of substantially parallel strands is disposed on top of said first plurality of strands and defines the second layer of strands, said second plurality of strands being at an angle relative to said first plurality of strands, and
said first and second plurality of strands are substantially incompressible and secured to one another at crossover locations; and
a geotextile bonded to at least one side of said of said geonet.

8. The geocomposite of claim 7, wherein at least one of said first and second plurality of strands is substantially round in cross-section.

9. The geocomposite of claim 7, wherein both of said first and second plurality of strands are substantially round in cross-section.

10. The geocomposite of claim 7, wherein said geotextile is non-woven textile laminated to the outer faces of said layers of strands.

11. The geocomposite of claim 10, wherein said strands are polyethylene (PE).

12. The geocomposite of claim 10, wherein said geotextile is non-woven needlepunched textile laminated to strands on both sides of said geonet.

13. The geocomposite of claim 7, wherein said geocomposite is stored in a roll having X number of layers with each strand of said first layer of strands being rolled X times.

14. The geocomposite of claim 7, wherein said geotextile is spun-bonded or needlepunched non-woven textile laminated to strands on both sides of said geonet.

15. A landfill comprising alternating layers of fill and geocomposites, said geocomposites each disposed beneath a layer of fill to facilitate draining of liquid from the landfill and including:
a geonet having a length substantially greater than its width, comprising
no more than first and second layers of strands, where
a first plurality of substantially parallel strands extends in the lengthwise direction and defines the first layer of strands,
a second plurality of substantially parallel strands is disposed on top of said first plurality of strands and defines the second layer of strands, said second plurality of strands being at an angle relative to said first plurality of strands, and
said first and second plurality of strands are substantially incompressible and secured to one another at crossover locations; and
a geotextile bonded to at least one side of said geonet.

16. The landfill of claim 15, wherein at least one of said first and second plurality of strands is substantially round in cross-section.

17. The landfill of claim 15, wherein said strands are polyethylene (PE).

18. A method of making a geonet for use in a geotechnical construction site, comprising:
providing a mold for extruded material including
a first mold member having an outer boundary cylindrical about an axis and defining a first plurality of strand defining openings open at said outer boundary and spaced around said outer boundary, and
a second mold member concentric with said first mold member and having a cylindrical inner boundary defining a second plurality of strand defining openings open at said inner boundary and spaced around said inner boundary;
forcing extruded material through said first and second plurality of strand defining openings while one of said first and second mold members is stationary and the other of said first and second mold members rotates to define a cylindrical net with the strands defined by the openings of said one of said first and second mold members each extending substantially parallel to said axis and the strands defined by the openings of said other of said first and second mold members spiraling around said cylindrical net; and
cutting said strands defined by the other of said first and second mold members along a line substantially parallel to said axis;
flattening the cut cylindrical net to generally orient said strands in a plane; and
rolling said flattened net whereby said strands defined by said one of said first and second mold members are coiled.

19. The method of claim 18, wherein the openings of said first plurality of openings are open to openings of said second plurality of openings when said openings of said first and second plurality of openings are aligned along a radius of said axis during relative rotation of said first and second mold members.

20. The method of claim 18, wherein one of said first and second plurality of openings is substantially rectangular in cross-section.

21. The method of claim 18, wherein said other of said first and second mold members rotates at a rate whereby the strands molded thereby are at an angle of 45° to 70° relative to the strands molded by said one of said first and second mold members.

22. A method of making a landfill comprising alternating layers of fill and geonets, said geonets each disposed beneath a layer of fill to facilitate draining of liquid from the landfill, including the step of rolling a geonet made according to claim 18 beneath each layer of landfill in the direction of expected drainage flow.
